(19) United States
(12) Patent Application Publication
(10) Pub. No.: US 2024/0163842 A1
(43) Pub. Date: May 16, 2024

(54) METHOD FOR EARLY INDICATION OF PAGING

(71) Applicant: Sony Group Corporation, Tokyo (JP)

(72) Inventors: Anders BERGGREN, Lund (SE); Basuki PRIYANTO, Lund (SE); Nafiseh Seyed MAZLOUM, Lund (SE); Torgny PALENIUS, Barsebäck (SE); Martin Warwick BEALE, Bristol (GB); Shin Horng WONG, Basingstoke (GB)

(21) Appl. No.: 18/283,402

(22) PCT Filed: Feb. 16, 2022
(86) PCT No.: PCT/EP2022/053855

§ 371 Date: Sep. 21, 2023

(30) Foreign Application Priority Data
Mar. 31, 2021 (SE) 2150415-4

(51) Int. Cl. H04W 68/02; H04W 52/02

(52) U.S. Cl. CPC H04W 68/02; H04W 52/0229; H04W 52/0235

(57) ABSTRACT

A method for a user equipment, UE, to monitor a paging occasion, PO (41), for obtaining a paging message from a base station, the method comprising: obtaining (801) configuration of a plurality of paging early indicator, PEI, occasions allocated in an indicator window (42) preceding the PO; monitoring (804) reception of a PEI in the indicator window; and monitoring (809) the PO, responsive to receiving, in at least one of the PEI occasions, a PEI indicating that the UE shall monitor said PO, or otherwise entering (811) a sleep state without monitoring the PO.

### TECHNICAL FIELD

The present disclosure relates to wireless communications, and, more particularly, to a solution for monitoring a paging occasion (PO). Specifically, methods and apparatuses are provided for providing early indication to wireless devices, prior to a paging occasion, to inter alia alert such wireless devices whether or not they need to monitor the paging occasion.

### BACKGROUND

The present disclosure relates broadly to wireless communication, in which wireless devices, herein referred to as User Equipment (UE), are served by a wireless network through an access network including access nodes. Such access nodes are herein referred to as base stations. The wireless network may operate under specifications provided within the 3^{rd} Generation Partnership Project (3GPP), and may be configured to communicate with the wireless devices by radio communication. A UE may be connected to the wireless network, and thereby being configured with resources for radio communication with one or more base stations. Alternatively, the UE may be in an unconnected state, with regards to the network, when there is no present or pending communication. Such a state may e.g. be referred to as idle or inactive, dependent on how the wireless network treats the context of the UE. A UE operating in idle/inactive mode needs to listen and monitor for potential paging reception from the access network, which is a way for the network to initiate transfer to the UE to connected mode and/or to indicate the transmission of a broadcast information, including system information (SI) update.

In various types of wireless networks, such as the 3GPP radio access technology 5G new radio (NR), a UE may use discontinuous reception (DRX), which inter alia has the benefit of reducing power consumption in the UE. When configured with DRX, the UE monitors one paging occasion (PO) per DRX cycle where each PO comprises a set of PDCCH (Physical Downlink Control Channel) monitoring occasions and can consist of multiple time slots, e.g. subframes or Orthogonal Frequency Division Multiplexing (OFDM) symbols. Paging may be carried out by a base station transmitting a so called paging DCI (Downlink Control Indicator), such as a DCI whose CRC (Cyclic Redundancy Check) is scrambled by P_RNTI (Paging Radio Network Temporary Identifier). One Paging Frame (PF) is one Radio Frame and may contain one or multiple PO(s) or starting points of a PO.

The paging reception procedure, in the UE, may include two steps:
First the UE needs to monitor the PDCCH for a paging DCI.
If the UE detects a paging DCI, the UE continues to the second step where the UE decodes the PDSCH (Physical Downlink Shared Channel) for a paging message.

Details of the frequency and time resources where the UE should receive the PDSCH containing a paging message are provided in the paging DCI. The paging message includes the IMSI/TMSI of the target UEs which have been paged. This information is obtained by the UE only after PDSCH decoding and at this stage the UE knows whether it is paged or not. The event where a UE detects/successfully decodes a paging DCI and the associated paging message in PDSCH, but that UE is as such not addressed, e.g. where the TMSI (Temporary Mobile Subscriber Identity) is not included in the PDSCH, is referred to as “false paging” and leads to an extra overhearing cost at the UE. Both idle-channel monitoring and paging-DCI overhearing lead to extra costs at the UE. Since the UE needs to be fully synchronized to be able to decode paging DCI and the paging message, these additional costs can become significant for instance in scenarios where the UE is not in very good coverage (e.g., in the cell-edge). The total extra costs depend on the paging probability and how the POs/DRX parameters of UEs with different paging probability are configured.

For these reasons, discussions have been initiated on UE paging enhancement addressing the above issues.
A new signal referred to as paging early indicator (PEI) is introduced. PEI is transmitted before the PO and the aim is to reduce the cost resulting from idle channel monitoring when listening for potential paging.
Carrying UE subgrouping information is included in the physical layer design of PEI to reduce idle channel monitoring and false paging or overhearing cost.

### SUMMARY

One problem that needs to be addressed is coexistence of PEI with transmissions to legacy UEs, i.e. any UE not configured or capable of receiving PEI or any legacy NR signal(s)/channel(s) transmissions that have been configured/reserved that may collide with the newly introduced PEI transmissions. This is since the time and frequency resources of any legacy NR signal/channel (which could include the PO of a legacy UE) can coincide with the time and frequency resources of a PEI transmission which in return can create scheduling conflicts or blocking for either of the two UEs, or at least legacy UEs.

The solutions proposed herein are set out in the independent claims. various examples associated with the proposed solution are presented in the dependent claims.

According to one aspect, a method is proposed for a UE to monitor a PO for obtaining a paging message from a base station, the method comprising:
obtaining configuration of a plurality of PEI occasions allocated in an indicator window preceding the PO;
monitoring reception of a PEI in the indicator window; and
   monitoring the PO, responsive to receiving, in at least one of the PEI occasions, a PEI indicating that the UE shall monitor said PO, or
   otherwise entering a sleep state without monitoring the PO.

According to another aspect, a method is provided for a base station to configure a UE to monitor a PO for a paging message transmitted from the base station, the method comprising:
configuring a plurality of paging early indicator, PEI, occasions during an indicator window preceding the PO, for use by the UE to monitor for a PEI transmitted by the base station;
transmitting, based on that the UE is to be scheduled, a PEI in at least one of said PEI occasions, indicating that the UE shall monitor said PO.

By providing an indicator window with a plurality of PEI occasions, multiple opportunities are obtained for supporting co-existence of resources that can be used for other traffic. Moreover, multiple or different purposes for the PEI occasions may be defined within the indicator window, which inter alia provides enhanced capability of minimizing false wake-ups.

Various further details and advantages associated with different embodiments of the proposed solution are set out in the description below.

### BRIEF DESCRIPTION OF THE DRAWINGS

The proposed solution is described in more detail below with reference to the accompanying drawings, in which various examples of realizing the solutions are outlined.

FIG. 1 schematically illustrates a wireless network according to some examples, in which the proposed solutions may be set out.

FIG. 2 schematically illustrates a UE configured to operate in accordance with the examples laid out herein.

FIG. 3 schematically illustrates a base station configured to operate in accordance with the examples laid out herein.

FIG. 4 schematically illustrates allocation of an indicator window comprising a plurality of PEI occasions, prior to an associated paging occasion.

FIGS. 5A and 5B schematically illustrate examples of configuration of the PEI occasions in the indicator window.

FIG. 6 schematically illustrates configuration and use of a confirmation PEI in the indicator window.

FIG. 7 schematically illustrates configuration and use of a specific PEI to minimize monitoring in the indicator window.

FIG. 8 is a flow chart of a method carried out in a UE according to various aspects associated with the proposed solution.

### DETAILED DESCRIPTION

In the following description, for purposes of explanation and not limitation, details are set forth herein related to various examples. However, it will be apparent to those skilled in the art that the present disclosure may be practiced in other examples that depart from these specific details. In some instances, detailed descriptions of well-known devices, circuits, and methods are omitted so as not to obscure the description of the present disclosure with unnecessary detail. The functions of the various elements including functional blocks, including but not limited to those labeled or described as “computer”, “processor” or “controller”, may be provided through the use of hardware such as circuit hardware and/or hardware capable of executing software in the form of coded instructions stored on computer readable medium. Thus, such functions and illustrated functional blocks are to be understood as being either hardware-implemented and/or computer-implemented and are thus machine-implemented. In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) (ASIC), and (where appropriate) state machines capable of performing such functions. In terms of computer implementation, a computer is generally understood to comprise one or more processors or one or more controllers, and the terms computer and processor and controller may be employed interchangeably herein. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” shall also be construed to refer to other hardware capable of performing such functions and/or executing software, such as the example hardware recited above.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

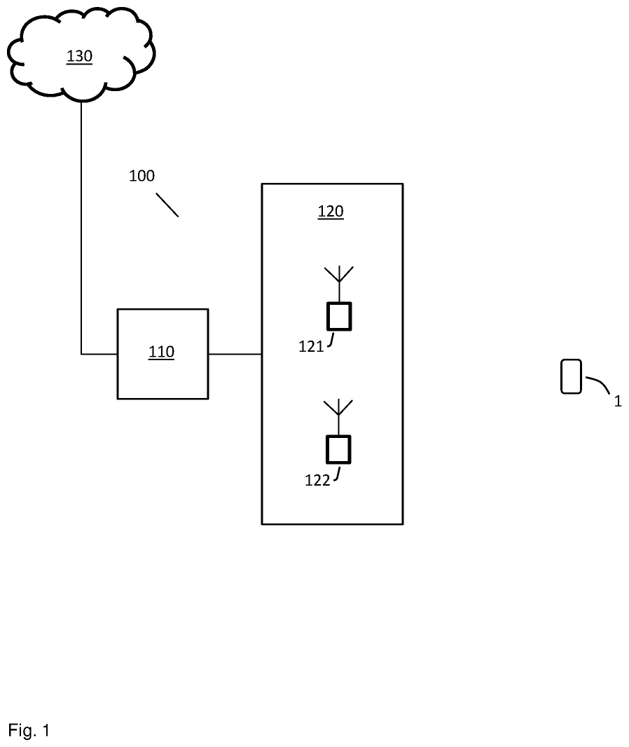

FIG. 1 schematically illustrates a wireless communication scenario, providing an example of a scenario in which the solutions provided herein may be incorporated. The wireless communication system includes a wireless network 100, and a UE (or wireless device) 1 configured to wirelessly communicate with the wireless network 100. The wireless network 100 comprises a core network 110, which is connected to other communication networks 130. The wireless network 100 further comprises one or more access networks 120, such as a 5G NR access network, usable for communication with UEs of the system. Such access networks may comprise a terrestrial network 120 comprising a plurality of access nodes or base stations 121, 122, configured to provide a wireless interface for, inter alia, the UE 1. For an NR implementation, the base station may be referred to as a gNB. The base stations 121, 122 may be stationary or mobile. Each base station comprises a point of transmission and reception, referred to as a Transmission and Reception Point (TRP), which coincides with an antenna of the respective base station. Logic for operating the base station may be configured at the TRP or at another physical location.

The UE 1 may be any device operable to wirelessly communicate with the network 100 through the base stations 121, 122, such as a mobile telephone, computer, tablet, a machine to machine (M2M) device, an IoT (Internet of Things) device or other.

Before discussing various process solutions for the proposed method, the UE 1 and a base station 121 will be functionally discussed on a general level.

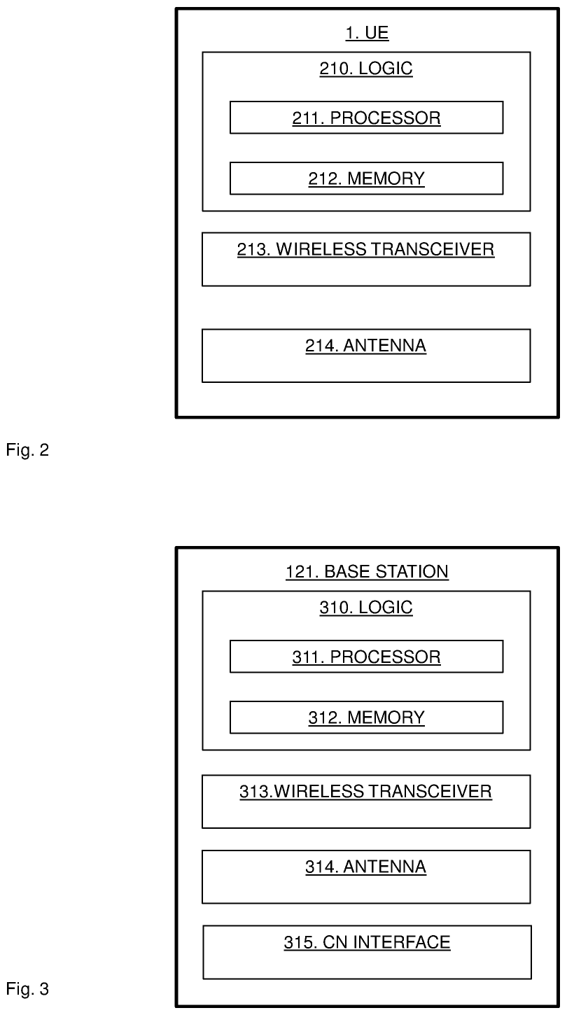

FIG. 2 schematically illustrates an example of the UE 1 for use in a wireless network 100 as presented herein, and for carrying out the method steps as outlined. The UE 1 may be a New Radio (NR) UE in which the UE may be arranged in a connected mode or in an unconnected mode, such as idle or inactive, with regard to a 5G NR cellular access network 120.

The UE 1 comprises a radio transceiver 213 for communicating with other entities of the radio communication network 100, such as the base stations 121, 122 in various frequency bands. The transceiver 213 may thus include a radio receiver and transmitter for communicating through at least an air interface.

The UE 1 further comprises logic 210 configured to communicate data, via the radio transceiver 213, on a radio channel, to at least the wireless communication network 100.

The logic 210 may include a processing device 211, including one or multiple processors, microprocessors, data processors, co-processors, and/or some other type of component that interprets and/or executes instructions and/or data. The processing device 211 may be implemented as hardware (e.g., a microprocessor, etc.) or a combination of hardware and software (e.g., a system-on-chip (SoC), an application-specific integrated circuit (ASIC), etc.). The processing device 211 may be configured to perform one or multiple operations based on an operating system and/or various applications or programs.

The logic 210 may further include memory storage 212, which may include one or multiple memories and/or one or multiple other types of storage media. For example, the memory storage 212 may include a random access memory (RAM), a dynamic random access memory (DRAM), a cache, a read only memory (ROM), a programmable read only memory (PROM), flash memory, and/or some other type of memory. The memory storage 212 may include a hard disk (e.g., a magnetic disk, an optical disk, a magneto-optic disk, a solid state disk, etc.). The memory storage 212 is configured for holding computer program code, which may be executed by the processing device 211, wherein the logic 210 is configured to control the UE 1 to carry out any of the method steps as provided herein. Software defined by said computer program code may include an application or a program that provides a function and/or a process. The software may include device firmware, an operating system (OS), or a variety of applications that may execute in the logic 210.

The UE 1 may further comprise an antenna system 214, which may include one or more antenna arrays. In various examples the antenna system 214 comprises different antenna elements configured to communicate with the wireless network 100.

Obviously, the UE 1 may include other features and elements than those shown in the drawing or described herein, such as a power supply, a casing, a user interface, sensors, etc., but these are left out for the sake of simplicity.

FIG. 3 schematically illustrates an example of a base station 121, such as a gNB.

The base station 121 comprises logic 310 configured to control wireless communication with UEs, and communication with the core network 110. The logic 310 may include a processing device 311, including one or multiple processors, microprocessors, data processors, co-processors, and/or some other type of component that interprets and/or executes instructions and/or data. The processing device 311 may be implemented as hardware (e.g., a microprocessor, etc.) or a combination of hardware and software (e.g., a system-on-chip (SoC), an application-specific integrated circuit (ASIC), etc.). The processing device 311 may be configured to perform one or multiple operations based on an operating system and/or various applications or programs.

The logic 310 may further include memory storage 312, which may include one or multiple memories and/or one or multiple other types of storage mediums. For example, the memory storage 312 may include a random access memory (RAM), a dynamic random access memory (DRAM), a cache, a read only memory (ROM), a programmable read only memory (PROM), flash memory, and/or some other type of memory. The memory storage 312 may include a hard disk (e.g., a magnetic disk, an optical disk, a magneto-optic disk, a solid state disk, etc.). The memory storage 312 is configured for holding computer program code, which may be executed by the processing device 311, wherein the logic 310 is configured to control the base station 121 to carry out any of the method steps as provided herein. Software defined by said computer program code may include an application or a program that provides a function and/or a process. The software may include device firmware, an operating system (OS), or a variety of applications that may execute in the logic 310.

The base station further comprises a radio transceiver 313 for communicating radio signals with UEs in various frequency bands. The transceiver 313 may thus include a radio receiver and transmitter for communicating through at least an air interface.

The base station 121 may further comprise, or alternatively be connected to, an antenna system 314, which may include one or more antenna arrays. The antenna system 314 is operable by means of the transceiver 313 to communicate with UEs.

In various embodiments, the base station may be arranged to transmit in a plurality of beams, e.g. in a mm (millimeter) wave part of the frequency spectrum, e.g. in Frequency Range (FR) 2. In such embodiments, different spatial configurations may be arranged for different beams transmitted by the antenna system 314.

The base station 121 further comprises a communication interface 315 for connection to the other nodes of the wireless network 100, such as the core network (CN) 110.

According to the solution outlined herein, it is proposed to add a mechanism to an implementation of paging early indication (PEI), which inter alia obtains the technical effect of reducing idle channel monitoring, false wake-ups and blocking when legacy data transmissions coincide with PEI. This enhanced PEI mechanism includes or defines:
inclusion of a window for scheduling/monitoring of PEI,
UE behavior when monitoring for PEI,
base station and network behavior when scheduling a PEI,
necessary configuration.

Discussion of these various aspects are outlined below. It shall be noted that, going forward, the base station 121 is at various places referred to as a gNB, which shall be seen as a non-limiting example.

According to one aspect, inclusion of a window is provided for scheduling and monitoring of potential PEI of a target UE or group of UEs, such as UEs operating in idle/inactive mode. The window includes several opportunities for transmission/reception of PEI. From the perspective of the UE 1, the proposed solution provides a method for monitoring a PO for obtaining a paging message from a base station, the method comprising:
obtaining configuration of a plurality of PEI occasions allocated in an indicator window preceding the PO;
monitoring reception of a PEI in the indicator window; and
   monitoring the PO, responsive to receiving, in at least one of the PEI occasions, a PEI indicating that the UE shall monitor said PO, or
   otherwise entering a sleep state without monitoring the PO.

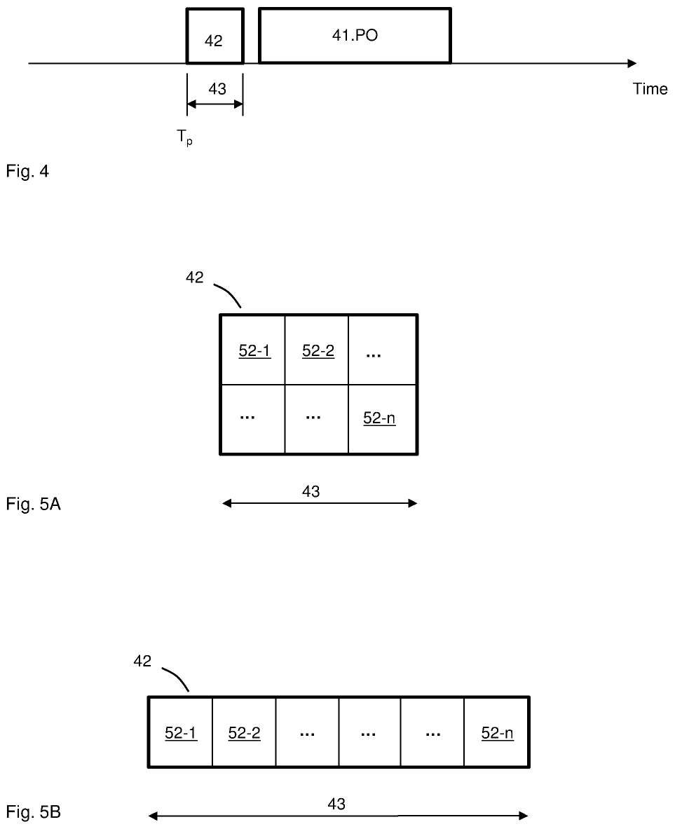

FIG. 4 schematically illustrates a diagram of time, in which a PO 41 is illustrated. Moreover, an indication opportunity window 42 is configured to precede the PO in time. The indicator window 42 comprises a plurality of PEI occasions, alternatively referred to herein as PEI opportunities. The indicator window 42, also referred to herein as PEI monitoring window, has a start time Tₚ and a duration 43. Configuration of the window 42 may be explicit, including start time and stop time, or the duration in combination with a certain time associated with start or stop, or with another point in time such as start of the PO 41. The configuration may be either implicitly or explicitly indicated to the UE 1 by the access network 120, such as the base station 121. From the perspective of the base station, each PEI occasion represents one opportunity to transmit a PEI. From the perspective of the UE 1, each PEI occasion represents one monitoring occasion to determine reception of a PEI. The time between the final monitoring occasion of the window 42 and the earliest time at which a paging DCI or paging message can be received based on the PO 41 needs to be longer or equal to a transition time required to switch on necessary hardware/a radio to receive a paging DCI and paging message.

FIGS. 5A and 5B provide examples of configuration of the PEI occasions within the window 42. In FIG. 5A a plurality of PEI occasions 52, including 52-1 to 52-n, are configured by allocation of resources separated by both time (horizontally) and frequency (vertically). In the example of FIG. 5B, a plurality of PEI occasions 52-1 to 52-n are configured by allocation of resources separated in time only, while being allocated to a common frequency resource. In such an embodiment, the duration 43 defines a time window of the monitoring window 42.

The configuration of resources to the different PEI occasions 52 in the window 42 may be configured by the base station 121 based on rules and/or ranges predetermined in technical specifications. The base station is in such an example configured to transmit the configuration of the indicator window 42, including resources for said PEI occasions 52, for reception in the UE 1. Transmission of the configuration may be carried out by broadcasting system information messages within system information blocks (SIB) or e.g. specifically addressed to the UE 1 in connected mode.

Hence by providing multiple opportunities for the PEI to be transmitted to a UE, the gNB can select one of these opportunities where the PEI transmission would not block other legacy transmissions or cause other inconvenience. Moreover, as will be outlined, the definition of multiple PEI opportunities provides further benefits in terms of conveying information related to the upcoming PO.

In various embodiments, the indicator window 42 supports so-called multi-beam operation. NR supports operation with multiple beams. In this context, the base station 121 may be configured to transmit a plurality of synchronization signal blocks, SSBs, in a burst. An SSB can be transmitted for every beam. In Release-16, there is a mapping between SSB and the beam on which the UE monitors for paging DCI and paging message. Hence, in Release-16, an IDLE mode UE performs the following functions:
Determine beam with best SSB metrics (e.g. strongest received signal power)
Attempt to decode paging DCI and paging message using the beam that was determined in the preceding step.

In context with the presently proposed solution, there are two potential alternative functionalities in terms of the order of reading SSB when PEI is used:
UE decodes/detects SSB before decoding/detecting PEI
UE decodes/detects PEI before decoding/detecting SSB

Embodiments related to these alternatives are discussed below. The UE may obtain association information which maps an identity associated with SSBs to resources related to the PEI occasions 52. The SSBs may in turn be associated with a certain beam, or beam identity, in a multi-beam operation mode of the access node 121. The association information may e.g. be predetermined and fixed for the base station, or configured at times and broadcast by SIB.

When the UE 1 monitors PEI reception, the UE 1 may in some embodiments detect SSB before PEI, i.e. prior to monitoring the PEI occasions 52. The UE 1 may thus receive one or more of said SSBs, and synchronize with at least one SSB to determine the associated identity of said at least one SSB. The UE 1 may in this context be arranged to determine the best beam using SSB, such as the strongest received SSB, before attempting to decode/detect PEI within the indicator window 42.

Once the SSB is determined, monitoring reception of a PEI is carried out on, and restricted to, the resources related to one or more PEI occasions 52 specifically associated with the associated identity, as determined based on the obtained association information. This way, a restricted number of PEI occasions to monitor may be obtained. Put differently, since there is an association between SSB and PEI resources, certain PEI resources, allocated to PEI occasions, are associated with certain beams thanks to the association between SSB and beam. The UE 1 thus only needs to monitor PEI from the best beam associated with the selected SSB. For the example of a PEI indicator window 42 consisting of 16 PEI occasions, the SSB association can take the form of:

| SSB | beam | PEI occasions associated with beam |
|---|---|---|
| SSB1 | 1 | {0, 4, 8, 12} |
| SSB2 | 2 | {1, 5, 9, 13} |
| SSB3 | 3 | {2, 6, 10, 14} |
| SSB4 | 4 | {3, 7, 11, 15} |

Each beam is thus associated with resources related to a subset of said plurality of PEI occasions, which subset comprises a multitude of PEI occasions. For the example of the UE determining that the preferred SSB is that with an identity of SSB1, the UE 1 needs only monitor for PEI reception in the subset of PEI occasions 0, 4, 8, 12 in the indicator window 42. Note that there may still, as exemplified, be multiple PEI occasions associated with each beam in the PEI window. This helps the coexistence issue, since if a beam needs to be used to serve a legacy UE in a first PEI occasion within the PEI indicator window, PEI can still be sent to the UE with that beam during a subsequent PEI occasion that is associated with the same beam. For a sequence-based PEI, the detection process to determine PEI reception can be a correlation between the received signal and known PEI sequences.

Once the UE has detected and decoded PEI, it can then decode the paging DCI and paging message. As per legacy operation, there is an association between SSB and paging DCI.

A technical effect of detecting SSB before PEI is that the UE 1 does not need to attempt to detect all PEI within the PEI indicator window. Additionally, the UE 1 can detect PEI coherently since the UE will be synchronized with the base station 121 after detecting SSB.

In an alternative embodiment, the UE 1 detects PEI, i.e. monitors for PEI reception in the indicator window 42, before detecting SSB. The UE 1 may then first receive a PEI in at least one of said PEI occasions 52. If the UE 1, or a subgroup including the UE 1, is not to be paged, no PEI configured to be detected by the UE 1 may be sent at all. For a sequence-based PEI, the detection process to determine PEI reception can be a correlation between the received signal and known PEI sequences. The UE needs to attempt to detect PEI for all potential beams within the PEI indicator window. At this stage of the detection process, the UE does not know which beam will be used for transmission of the PEI and hence the UE needs to attempt to detect PEI on any beam.

The base station 121 may be configured to transmit the PEI more than once using the same beam, or transmit in one out of a multitude of possible PEI occasions 52, in the indicator window 42. If the UE knows that the PEI will be sent more than once during the PEI indicator window, it can apply the following detection algorithm:
Attempt to detect PEI in the PEI occasion that was associated with the SSB and beam that was previously used for communication with this UE 1. This assumes that the UE 1 has not moved since the last connection.
If PEI was not detected in the previous step, attempt to detect PEI in all remaining PEI occasions 52 within the indicator window 42. This step caters for the case that the UE has moved.

The UE 1 may decode the PEI, and determine the identity of at least one of said SSBs, based on the decoding. This is possible due to the obtainment of the association information which maps identity associated with SSBs to resources related to the PEI occasions 52, as mentioned. Once the UE 1 has detected a PEI on certain PEI resources, the UE can thus determine which beam was used to transmit the PEI.

The UE may attempt to synchronize with an SSB associated with the determined identity, i.e. with the SSB associated with the beam associated with the PEI that was detected and decoded. The UE 1 may then proceed to read paging DCI associated with the SSB and beam that was detected when monitoring PEI resources, where the detected beam is confirmed in the SSB decoding phase.

One advantage of detecting PEI before SSB is that the UE does not need to synchronize with the SSB before detecting PEI, given that synchronization with SSB can be more costly in terms of power consumption than more simple correlation with and decoding of PEI.

On a general level, the proposed solution may be applied for different scenarios or use cases for transmitting PEI, including:
(i) When PEI is used as a WUS (wake up signal)
(ii) When PEI indicates both WU (wake up) and GTS (go to sleep)

In this context it may be noted that WU is used herein to denote an indication to wake up, whereas WUS is the signal that carries such an indication, such as a certain detectable sequence. A PEI is therefore occasionally referred to as being used as a WUS, or to indicate WU, which has the same fundamental technical effect. Correspondingly, GTS is used herein to denote an indication to go to sleep, or enter a sleep mode, whereas GTSS is the signal that carries such an indication, such as another detectable sequence.

In various embodiments, the UE is not required to monitor all opportunities, i.e. all possible PEI occasions 52. In some embodiments, once the UE 1 has detected a PEI in a PEI occasion 52, the UE 1 can skip monitoring the remaining opportunities, and proceed in accordance with the received PEI.

Various embodiments will now be outlined with respect to UE behavior when PEI is used as at least a WUS. In these embodiments, the monitoring for reception of a PEI is carried out to determine reception of a WUS, indicating that a paging message may be scheduled for the UE in said PO.

The UE 1 is arranged to monitor for PEI reception in said PEI occasions in succession in accordance with a monitoring sequence, wherein the UE 1 listens for potential PEI by starting to monitor the first PEI occasion, or opportunity, 52-1. The first PEI occasion 52-1 may be defined as the earliest PEI occasion, in the time domain, within the indicator window 42. Where configuration of resources for the PEI occasions are allocated at different frequencies, such as in FIG. 5A, a predetermined one of the PEI occasions allocated earliest in the time domain may be pre-configured as a starting PEI occasion, i.e. as the first PEI occasion to monitor.

In some embodiments, monitoring reception of a PEI includes the UE monitoring said PEI occasions in succession, according to the monitoring sequence, and proceeding to monitor the PO responsive to receiving a WUS in one of said PEI occasions, without monitoring any subsequent PEI occasion in the opportunity window. This entails that if WU is indicated to UE 1 in one of the PEI occasions, the UE 1 does not need to monitor for further WUS in the window.

In some embodiments, the UE 1 may be aware that one or more of the PEI occasions collide with a certain signal or channel, for example SSB, SIB1, PDCCH common search space, or other. In such a scenario, the UE 1 doesn't have to monitor that certain PEI occasion(s). The benefit is the UE will save some power, based on reduced PEI monitoring in the indicator window 42. In such an embodiment, said reception of a PEI, by the UE 1, may comprise:
skipping monitoring of at least one PEI occasion based on knowledge in the UE 1 of such at least one PEI occasion being co-located with another configured signal or channel.

In some embodiments, some of the PEI monitoring occasions within the indicator window 42 have different functionalities than others. Examples include the following configurations:

At least one of said PEI occasions 52 is reserved for a PEI addressed to identified UEs. In some embodiments, if the indicator window 42 consists of n PEI monitoring occasions, the first n-1 PEI monitoring occasions are reserved for a PEI addressed to identified UEs, either UE-specific or a subgroup-specific PEI monitoring occasions. A large number of sequences for the PEI signal would be required to be able to wake up all UEs individually, and each UE would have to correlate for a long time to see if it is indicated, since the window might have to be large to accommodate all of the UEs. Hence, subgroup-specific PEI monitoring occasions allow the base station to wake up one or a small number of UEs. A sub-group mechanism could reduce the number of sequence required to be transmitted in the same window and/or reduce the window size. In some embodiments, a subgroup may be configured randomly, such as based on IMSI ending with a certain number. Other alternative subgroup configurations may be based on some definition of UE type or category, or based on paging probability determined based on collected data. In some embodiments, a subset of the n-1 PEI occasions is reserved for subgroup-specific PEI, and various UEs of such subgroups may be configured to only monitor such subgroup-specific PEI occasions, thereby minimizing monitoring time for those UEs. In some embodiments, monitoring the PO is thus carried out on the condition that the received PEI is addressed specifically to the UE or to a subgroup comprising the UE.

In the event of the base station was unable to send a WUS to a UE during one of the first n-1 PEI occasions, e.g. due to scheduling conflicts, it could wake-up all UEs in the last PEI monitoring occasion with a single PEI transmission. In this embodiment, the last PEI occasion 52-n acts as a group PEI, reserved for group WUS. In this context, a group PEI may refer to a larger group than a subgroup, or alternatively to an un-specified group comprising all UEs configured to monitor PEI.

This embodiment helps with coexistence with legacy UEs, since it lessens the scheduling restrictions on legacy UEs. Less resources are required to be specifically reserved for PEI signaling, since only the group PEI signal resource needs to be reserved. The group PEI signal needs to be decoded reliably by UEs.

In a variant of the above-referenced embodiment, every m-th PEI occasion acts as a group PEI, with a similar rationale to that described in the previous paragraph. For example, if the PEI monitoring window consisted of 8 PEI occasions, occasions 1,2,3,5,6,7 could be used for UE-specific or subgroup-specific PEI and monitoring occasions 4,8 could be used for group PEI. If the gNB had been unable to signal PEI to a UE in monitoring occasions 1,2 or 3, it could send the group PEI in monitoring occasion 4 (or 8). If the gNB had been unable to signal PEI to a UE in monitoring occasion 5,6 or 7, it could send the group PEI in monitoring occasion 8. A benefit of such an embodiment is that the base station cannot reliably know if it will be able to transmit a WUS PEI in future PEI occasions. By providing an opportunity every m-th PEI occasion for group WUS, and at least more than one PEI occasion reserved for group WUS in the indicator window 42, it increases the chances for transmitting WUS to all UEs that will be paged in the subsequent PO.

The potential locations for PEI can be the same as those used by other legacy transmissions. For example, PRB1 (physical resource block 1) could be used to either (1) transmit PDSCH to a legacy UE or (2) transmit PEI to a UE that is monitoring the PEI window. There may then be cross-correlation between PEI and the legacy transmission, e.g. if the base station 121 transmits a PDSCH, there is a possibility that a UE monitoring for PEI incorrectly determines that PEI was active by the PDSCH cross-correlating with the PEI sequence. If the PEI acts, or is interpreted, as a WUS, this is not a too problematic as the only downside would be false wake ups, which may only slightly increase the power consumption. If this issue is a problem, for example if there is a large number of false wake ups in a cell that is heavily loaded with legacy UEs, one or more of the PEI locations can be used to confirm the existence (or non-existence) of earlier PEIs transmitted in the PEI monitoring window. In some embodiments, the UE 1 is thus configured to monitor the PO responsive to detecting a WUS in one of said PEI occasions and detecting a confirmation PEI in another of said PEI occasions. A confirmation PEI may thus be transmitted from the base station 121 to verify that another PEI in the PEI monitoring window was active, and/or that a particular type of PEI was transmitted, e.g. verifying that that the PEI monitoring window contained WUS transmission. Detailed options are considered in the following examples.

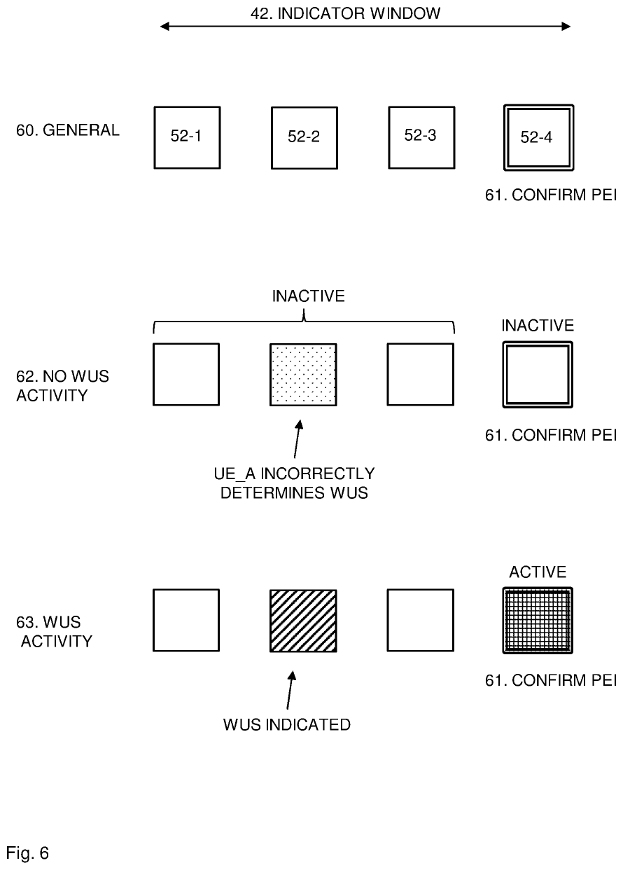

FIG. 6 schematically illustrates a configuration of PEI occasions 52-1 to 52-4 in an indicator window 42. In this embodiment, a confirm PEI 61 is configured to be used by the transmitting base station 121 to indicate that one or more of the PEIs had been active in the PEI monitoring window 42. The top part of this figure shows the general functionality of the configuration, where the first PEI occasions 52-1 to 52-3 may be configured to transmit at least one particular type of PEI, such as a WUS. The last PEI 52-4 in the PEI monitoring window 42 is used for the “confirm PEI” 61 function. In alternative embodiments, another PEI occasion than the last one in the indicator window 42 may be reserved for the confirm PEI 61.

The middle part of the figure shows a case where none of the PEI monitoring occasions within the PEI monitoring window is active. In other words, no PEI is transmitted by the base station 121. In this case, the confirm PEI 61 is inactive, meaning that e.g. WUS had not been sent during the PEI monitoring window 42. However, a UE_A had incorrectly determined WU, for example due to cross-correlation of a WUS sequence with the waveform for legacy NR transmissions. Since confirm PEI 61 is inactive, the UE_A would determine, based on detecting the active confirm PEI 61, that the WUS that it had successfully correlated with had not actually been transmitted. UE_A hence does not need to wake up.

The lower part of the figure shows the case where there is an active WUS PEI for UE_A during the PEI monitoring window 42. UE_A observes the WUS and the confirm PEI 61 indicates that a WUS has actually been sent during the PEI monitoring window 42, meaning that UE_A is triggered to wake up to monitor the PO.

While the previous embodiment, outlined with reference to FIG. 6, described a confirm PEI 61 that is applicable to the PEI monitoring window as a whole, it may be noted that the confirm PEI indication can in variants of that embodiment apply to subgroups of UEs. If two subgroups of UEs are defined, the “confirm PEI” can indicate that either:
WUS was sent to a UE of a 1^{st} subgroup during the PEI monitoring window 42. If any UE from the 1^{st} subgroup received the confirm PEI 61 and had also received a WUS during the PEI monitoring window 42, it would wake up.
WUS was sent to a UE of a 2^{nd} second subgroup during the PEI monitoring window 42. If any UE from the 2^{nd} subgroup received this “confirm PEI” and had also received a WUS during the PEI monitoring window, it would wake up.
WUS was sent to a UE from either the 1^{st} subgroup or the 2^{nd} subgroup during the PEI monitoring window 42. In this case, since all UEs have received the confirm PEI 61, any UE that had received a WUS during the PEI monitoring window would wake up.

In this embodiment, the confirm PEI can thus take on more than one character, such as by using different correlation sequences, wherein said confirmation PEI identifies that a WUS was addressed to a certain subgroup.

In an alternative embodiment, which is built on the rationale of a confirmation PEI, a confirm PEI 61 is used to identify that a WUS was not sent in any of the PEI occasions of the indicator window 42. This is equivalent to a “confirm PEI not sent” signal. In this embodiment, the base station 121 is configured to send a “confirm PEI not sent” signal at the end of the PEI monitoring window if no PEI had been sent in any of the PEI monitoring occasions within the PEI monitoring window.

An advantage of a “confirm PEI not sent” signal is that the base station 121 does not need to send this signal if there are scheduling restrictions in the PEI monitoring occasion where it would be sent (i.e. typically the last PEI occasion). If the base station 121 is unable to send a “confirm PEI not sent” signal, UEs that had incorrectly detected WUS would wake up at the paging occasion, but the power consumption implications of this inadvertent wake up would not be significant.

As noted, any of the PEI occasions of the indicator window 42 may be reserved for the confirm PEI 61, and not specifically the last one as in the examples described with reference to FIG. 6. Such a confirm PEI signal would indicate that any UE that had received a WU indication during the PEI monitoring window should indeed wake up.

Going forward, various embodiments of functionality and UE behavior will be discussed for the scenario that PEI is used to indicate both WU and GTS, i.e. where PEI can indicate different functionality, for example either WU or GTS. In these embodiments, the monitoring for reception of a PEI is additionally carried out to determine reception of a GTS, indicating that the UE shall not monitor the PO, and thus not wake up.

In some embodiments, a single PEI can indicate different functionality, such as either WU or GTS, by one of the following techniques:
WUS is signaled via a first sequence and GTSS is signaled via a second sequence. The UE is configured to correlate for both of these sequences to determine what functionality is being signaled.
WUS is signaled via a first cyclic shift of a sequence and GTSS is signaled by a second shift of the sequence. The UE can then be configured to perform a correlation with the sequence wherein the time location, or “amount of shift” location, of the correlation peak would indicate whether WUS or GTSS is signaled.
WUS is signaled by a first scrambling code applied to the sequence and GTSS is signaled by a second scrambling code applied to the sequence.

The UE is thereby configured to determine, based on PEI reception, whether the received PEI indicates WU or GTS.

In some embodiments, the UE is configured to determine reception of an instruction to proceed to either monitor the PO 41, i.e. determination of a WU instruction, or to go to sleep, i.e. determination of a GTS instruction, based on a combination of information received in a plurality of the monitored PEI occasions. This may for instance be determined based on detecting reception in at least one PEI occasion, and further detecting reception of a confirmation PEI in another PEI occasion, as outlined in various examples above. As another embodiment, this may be determined based on detecting reception in at least one PEI occasion providing a first indication, e.g. WU or GTS, and subsequent reception in another PEI occasion which overrides the first indication. Further examples of such an embodiment are outlined below.

In various embodiments, the UE may be configured to terminate monitoring of PEI during the indicator window 42 if either WUS or GTSS is received. This may be arranged in accordance with various different examples, as set out below.

In one example, the UE 1 is configured to listen for potential PEI by starting to monitor the PEI occasions within the PEI monitoring window, such as in the mentioned monitoring sequence order. If the UE 1 detects a PEI that is either a WUS or a GTSS, the UE 1 ends the PEI monitoring and:
If WUS was detected, the UE proceeds to decode the paging DCI and paging message.
If GTSS was detected, the UE can go to sleep.

In one version of this example the UE 1 is configured to terminate monitoring of PEI occasions configured to carry WUS or GTSS, but to monitor a confirm PEI 61, where applicable.

If no PEI is detected in a PEI occasion 52-1, the UE continues to monitor the next PEI monitoring occasion 52-2 and so on within the PEI monitoring window 42.

In another example, the UE 1 is configured to continue to monitor for PEI during a PEI monitoring window 42. In this embodiment, the UE 1 keeps monitoring for PEI, either WUS or GTSS, even after a WUS or GTSS has been received within the PEI monitoring window. Embodiments may e.g. apply one of the following two examples:

In a first example of this embodiment, if the UE 1 receives WUS, it keeps monitoring the PEI monitoring window. The UE can then monitor for only GTSS. This embodiment can be applied when the base station 121 uses the following scheduling strategy:

The base station 121 sends a group WUS in the PEI monitoring window as it knows that there are many legacy UEs to schedule at the time of the PEI monitoring window 42. Hence the gNB wakes up a group of UEs “just in case” it cannot send them UE-specific WUS at a later time within the PEI monitoring window 42. If there is actually spare resource within the PEI monitoring window (resource not used for legacy UEs), the gNB can then send GTSS to those UEs that do not actually need to wake up. In this scenario, the UE may thus monitor the PEI occasions 52 in succession, and proceed, responsive to receiving a WUS in one of said PEI occasions, to strictly monitor subsequent PEI occasions in the indicator window for a GTSS.

In a second example, if the UE 1 receives GTSS in the PEI monitoring window 42, it keeps monitoring the PEI monitoring window. The UE can then monitor for only WUS. This embodiment can be applied when the base station 121 uses the following scheduling strategy:

At the start of the PEI monitoring window 42 the base station 121 determines that no UEs need to be paged. The base station 121 then sends GTS signal(s) at the start of the PEI monitoring period 42. The base station 121 is then able to update this indication later if a paging event happens during the ongoing PEI monitoring period 42. In this scenario, the UE may thus monitor the PEI occasions 52 in succession, and proceed, responsive to receiving a GTSS in one of said PEI occasions, to strictly monitor subsequent PEI occasions in the indicator window for a WUS.

In various embodiments, different PEI monitoring occasions 52 are configured to have different functionality. For example, some PEI monitoring occasions relate to WU functionality and other PEI monitoring occasions relate to GTS functionality.

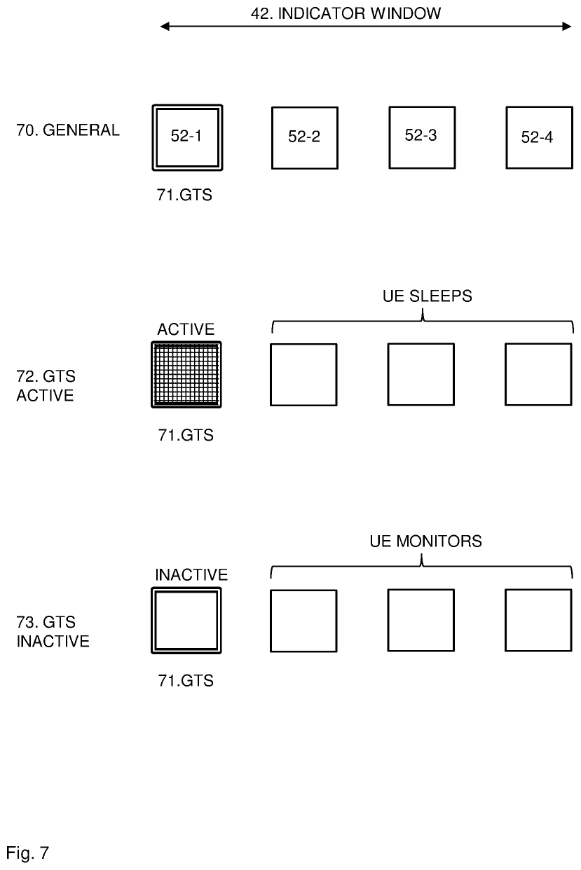

FIG. 7 schematically illustrates a configuration of PEI occasions 52-1 to 52-4 in an indicator window 42. In this embodiment, the first PEI monitoring occasion 52-1 within the PEI monitoring window 42 acts as a group GTS PEI 71, and the other PEI monitoring occasions 52-2 to 52-4 act as UE-specific or subgroup-specific PEI monitoring occasions.

There is a cost in terms of power consumption for measuring multiple PEI monitoring occasions within a PEI monitoring window. This embodiment thus allows UEs to sleep and save power consumption if it is known to the base station 121 that no UEs (or no UEs within a subgroup, wherein the GPS PEI 71 may be configured to be identified only for such a subgroup) will be woken up during the PEI monitoring window 42. The top part of FIG. 7 shows how the GTS PEI 71 and remaining PEI occasions for conveying WUS are ordered within the PEI monitoring window. The middle part of the figure shows the case that the GTS PEI is active, i.e. that a signal is transmitted by the base station in that PEI, which signal can be identified as a GTS. In this case, UEs can go to sleep for the remainder of the PEI monitoring window and hence save power. The lowest part of the figure shows the case that GTS is inactive. In this case, UEs monitor for WUS during the remainder of the PEI monitoring window, or until a WUS is detected.

In some embodiments, wherein one or more UEs are to be woken up within the PEI monitoring window, the first PEI monitoring occasion within the window can be used as a WUS. In other words, during the first PEI monitoring occasion 52-1 within the monitoring window 42, the UE may be configured to monitor for both GTS and WU sequences. The UE would hence perform more than one correlation during the same PEI occasion. In variants of this embodiment, this is applicable to any PEI monitoring occasion and not specifically the first PEI occasion.

While FIG. 7 indicates that first PEI occasion is reserved for a GTS PEI 71, it will be appreciated that the GTS PEI 71 can be applied anywhere within the PEI monitoring window 42. There are at least two alternative cases:

In a first case, if there is a GTS signal anywhere within the PEI monitoring window 42, any UE monitoring for PEI may go to sleep. Even if a UE had received a WUS earlier in the PEI monitoring window 42, the UE may go to sleep. The UE might have received a WUS earlier for several reasons, including a WUS false alarm and that the base station had initially intended to wake the UE up, but then made a different scheduling decision. The GTS would then act to cancel this decision.

In a second case, if there is a GTS signal in the m-th PEI occasion within the PEI monitoring window:
UEs that had received WUS in any PEI monitoring occasion between the 1^{st} and (m-1)th wake up.
UEs that had not previously received a WUS in the PEI monitoring window go to sleep.

This embodiment allows the base station 121 to implement the following functionality: once the base station 121 has woken up UEs that need to be woken up, it can allow those UEs that are not to be woken up to go to sleep and save power. This embodiment thus helps save power by dynamically reducing the size of the PEI monitoring window 42, the shorter the PEI monitoring window, the more power a UE can save.

Various embodiments have been described herein related to how there can be different functionalities within the PEI monitoring window 42, such as e.g. some PEI monitoring occasions being used for WU functionality and others for GTS functionality. It shall be noted that in some embodiments the functionality can be changed from one PEI monitoring window 42 to the next, wherein the UE is notified so as to be configured to monitor the next monitoring window according to the changed functionality. From the UE 1 perspective, this embodiment thus involves the UE receiving a PEI functionality indicator from the base station 121, wherein monitoring reception of a PEI is carried out in accordance with the PEI functionality indicator.

In one example, paging DCI or paging message is used to convey the PEI functionality indicator, which acts as a trigger for the UE to change behavior in a subsequent monitoring window 42, based on changed functionality of PEI occasions within that subsequent indicator window 42. If the base station 121 wishes to change PEI operation, it can wake UEs up during a first PEI window 42 such that UEs read the paging DCI and/or paging message. The paging DCI/paging message itself would then indicate, by the PEI functionality indicator, how a subsequent PEI window 42 should be handled. E.g. if the cell is heavily loaded, the paging DCI/paging message could indicate that UEs should monitor for group WUS PEI, where fewer group PEIs are required compared to UE-specific or subgroup-specific PEIs. The PEI functionality indicator thus configures the UE to either monitor for a PEI addressed to the UE, or to monitor for a group PEI.

In this example, the reconfiguration of the PEI occasions for a subsequent indicator window 42 is arranged without the UE having to transfer to connected mode.

There is a table of PEI monitoring window functionalities that can be RRC configured (e.g. via SIB signaling). The paging DCI or paging message may then indicate the index of the table that the UE should use for the configuration of future PEI monitoring windows. E.g. the table can consist of two entries, as exemplified below.

| index | Functionality |
|---|---|
| 0 | UE monitors for group WUS PEI |
| 1 | UE monitors for UE-specific PEI |

In this case:
if the PEI functionality indicator indicates ‘0’, the UE would monitor for group-WUS during the following PEI monitoring window;
if the paging DCI indicates ‘1’, the UE would monitor for UE-specific WUS during the following PEI monitoring window.

In some embodiments, the PEI functionality indicator may convey, to receiving UEs, a way that a PEI shall be interpreted within the PEI monitoring window. The receiving UEs can be a specific UE(s) or all UEs in that cell. An example of such an embodiment is provided in the table below.

| index | Functionality |
|---|---|
| 0 | Interpret PEI as WU |
| 1 | Interpret PEI as GTS |

In this embodiment, the UE 1 is configured to monitor for one PEI sequence during the PEI monitoring window 42, e.g. correlate for one PEI sequence. If the PEI functionality indicator had identified index ‘0’ in a previous paging DCI/message, the UE 1 would interpret the PEI as having WU functionality. If index ‘1’ had been identified in the paging DCI/message, the UE 1 would interpret the PEI as having GTS functionality. This way, the PEI functionality indicator configures the UE 1 to either interpret a PEI sequence received in said PEI occasions as a WU indication or as a GTS indication. This embodiment allows for the base station 121 to change its scheduling strategy, e.g. based on whether the base station 121 wants to use WU functionality or GTS functionality in the PEI monitoring window 42. Moreover, UEs could be restricted to detect only one type of sequence conveyed in the PEI occasions or to appropriately detect either WU or GTS, hence saving UE processing power.

Additional indices (3, 4, and so on) may be defined for further functionalities, such as one functionality index indicating that the UE shall monitor any PEI occasion, or one or more specific PEI occasion, for detection of indication of either WU or GTS.

With regard to behavior of the wireless network 100 when operating with PEI, and specifically behavior of the base station 121, a legacy UE can be paged via legacy methods. The legacy UE is sent a paging DCI and paging message, and it does not need to monitor PEI.

A UE 1 operating according to the solutions proposed herein will first attempt to read either a WUS or GTSS within the indicator window 42. If the UE 1 receives a PEI indicating that the UE shall monitor said PO, such as WU not overridden by a GTS, it proceeds to monitor for paging DCI and paging message in the same manner as a legacy UE. The network hence performs the following steps to schedule a UE operating according to various embodiments:

For WU functionality:
send PEI indicating WU during PEI monitoring window;
send paging DCI;
send paging message.

For GTS functionality:
do not send GTS during PEI monitoring window;
send paging DCI;
send paging message.

In order to schedule a UE operating according to this embodiment in a system also supporting other UEs (legacy UEs), the base station 121 performs the following functions:

For each PEI monitoring occasion during the PEI monitoring window:
determine whether a legacy UE is to be scheduled in the resources used for PEI, e.g. according to legacy scheduling algorithm;
if legacy UE is to be scheduled, schedule legacy UE and do not send PEI in this PEI monitoring occasion;
if no legacy UE needs to be scheduled in the resources used for PEI, i.e. resources for the PEI occasions 52 in the indicator window 42, send PEI, and do not send further PEI for that UE during the PEI monitoring window unless the scheduling decision is changed.

If the base station 121 had been able to instruct the UE 1 to wake up, i.e. was able to transmit a WUS, during the PEI monitoring window:
send paging DCI and paging message during the paging occasion.

As noted, the configuration of PEI is in various embodiments conveyed by the base station 121 to UE 1, e.g. using system information (SI). The configuration of PEI may comprise one or more of the following:
1. Resource multiplexing: Multiple PEI occasions/opportunities 52 can be configured within a time window (i.e, multiplexed in time domain) and/or within a frequency allocation (i.e, multiplexed in frequency domain).
2. Functionality: Either WU or WU and GTS.
3. Other configurations according to the embodiments described in the foregoing.

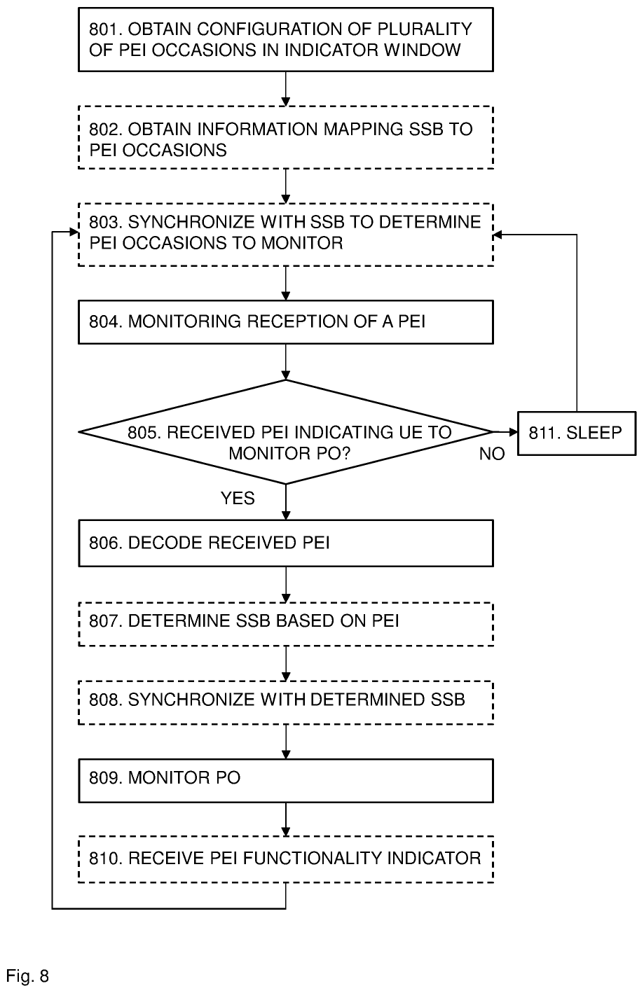

FIG. 8 shows a flow chart of various method steps associated with the UE 1. Some alternative embodiments are indicated by dashed lines. These steps, and various examples of them, have been described in the foregoing, and relate to a method for the UE 1 to monitor a PO, for obtaining a paging message from a base station 121.

In step 801, the UE 1 obtains configuration of a plurality of paging early indicator, PEI, occasions allocated in an indicator window preceding the PO. The configuration may be obtained from the base station 121.

In step 804, the UE 1 monitors reception of a PEI in the indicator window. This may entail detecting reception in the PEI occasions of the time window according to a configured monitoring sequence.

Based on the monitoring 804 resulting in receiving 805, in at least one of the PEI occasions, a PEI indicating that the UE shall monitor said PO, the UE will proceed to monitor 809 the PO. The PEI may in this context be a WUS.

Monitoring the PO may be preceded by decoding 806 the received PEI to identify resource for an associated paging DCI.

Based on the monitoring 804 not identifying that the UE shall monitor said PO, the UE 1 will enter 811 a sleep state without monitoring the PO. This may e.g. be the result of not receiving a WUS, or in case a WUS was received, the reception of a further PEI in the indicator window 42 which overrides the WUS. Such further PEI may e.g. be a GTSS obtained after the WUS, or an indication of a confirmation PEI indicating that the WU indication was not intended for the UE 1.

In various embodiments, the base station 121 transmits a plurality of synchronization signal blocks, SSB, in a burst. In such a case, the method may further comprise:
obtaining 802 association information which maps identity associated with said SSBs to resources related to said PEI occasions.

In one variant, the UE 1 will then
synchronize 803 with at least one SSB to determine the associated identity of said at least one SSB. The monitoring 804 for reception of a PEI may then be carried out on the resources related to one or more PEI occasions associated with the determined associated identity, which defines a subset of the plurality of PEI occasions in the indicator window.

In another variant of this embodiment, the UE 1 will instead first receive 805 a PEI in at least one of said PEI occasions. Based on the received PEI, the UE will then
determine 807 the identity of at least one of said SSBs. This may be accomplished by the decoding 806 of the received PEI. The UE will thereafter
synchronize 808 with an SSB associated with the determined identity.

Once monitoring 809 of the PO is carried out, by receiving paging DCI and a paging message, and potentially transferring to connected mode, the UE 1 will subsequently return to idle/inactive (e.g., in case there is no further downlink data).

In some embodiments, the UE 1 may
receive 810, from the base station 121, a PEI functionality indicator, wherein monitoring reception of a PEI is carried out in accordance with the PEI functionality indicator. Specifically, the PEI functionality indicator may define how a subsequent indicator window shall be handled. The PEI functionality indicator may be obtained upon monitoring 809 the PO.

After entering 811 sleep mode, or completing any tasks triggered by the PO 810, the UE 1 may return to monitor 804 the next indicator window, possibly preceded by attempting again to synchronize 803 with SSBs.

Various aspects of the proposed solution have been outlined in the foregoing. Except for where they are clearly contradictory, these embodiments may be combined in any way. Aspects of the proposed solution are set out in the list of items provided below.

Item 1. Method for a user equipment, UE, to monitor a paging occasion, PO, for obtaining a paging message from a base station, the method comprising:
obtaining (801) configuration of a plurality of paging early indicator, PEI, occasions allocated in an indicator window preceding the PO;
monitoring (804) reception of a PEI in the indicator window; and
   monitoring (809) the PO, responsive to receiving, in at least one of the PEI occasions, a PEI indicating that the UE shall monitor said PO, or
   otherwise entering (811) a sleep state without monitoring the PO.

Item 2. The method of item 1, wherein said base station transmits a plurality of synchronization signal blocks, SSB, in a burst, the method further comprising:
obtaining (802) association information which maps identity associated with said SSBs to resources related to said PEI occasions.

Item 3. The method of item 2, comprising:
synchronizing (803) with at least one SSB to determine the associated identity of said at least one SSB;
wherein said monitoring reception of a PEI is carried out on the resources related to one or more PEI occasions associated with the determined associated identity.

Item 4. The method of item 2, comprising:
receiving (805) a PEI in at least one of said PEI occasions;
determining (807) the identity of at least one of said SSBs, based on the received PEI;
synchronizing (808) with an SSB associated with the determined identity.

Item 5. The method of any of items 2-4, wherein said base station transmits in multiple beams, and wherein each beam is associated with resources related to a subset of said plurality of PEI occasions, which subset comprises a multitude of PEI occasions.

Item 6. The method of any preceding item, wherein at least one of said PEI occasions is reserved for a PEI addressed to identified UEs.

Item 7. The method of item 6, wherein monitoring the PO is conditionally carried out responsive to the received PEI being addressed specifically to the UE or to a subgroup comprising the UE.

Item 8. The method of any preceding item, wherein said monitoring reception of a PEI is carried out to determine reception of a wake up signal, WUS, indicating that a paging message may be scheduled for the UE in said PO.

Item 9. The method of item 8, wherein at least one of said PEI occasions is reserved for a group WUS.

Item 10. The method of item 8 or 9, wherein said monitoring reception of a PEI comprises:
monitoring said PEI occasions in succession; and
proceeding to monitor the PO, responsive to receiving a WUS in one of said PEI occasions, without monitoring any subsequent PEI occasion in the indicator window.

Item 11. The method of item 10, wherein said monitoring reception of a PEI comprises:
skipping monitoring of at least one PEI occasion based on knowledge in the UE 1 of such at least one PEI occasion being co-located with another configured signal or channel.

Item 12. The method of any of items 8-11, wherein monitoring the PO is carried out responsive to detecting a WUS in one of said PEI occasions, and detecting a confirmation PEI in another of said PEI occasions.

Item 13. The method of item 12, wherein at least one of said PEI occasions is reserved for said confirmation PEI.

Item 14. The method of item 12 or 13, wherein the confirmation PEI identifies that a WUS was sent in one or more of the PEI occasions of the indicator window.

Item 15. The method of any of items 12-14 wherein said confirmation PEI identifies that said WUS was addressed to a subgroup comprising the UE.

Item 16. The method of any of items 12-14, wherein a confirmation PEI identifies that a WUS was not sent in any of the PEI occasions of the indicator window.

Item 17. The method of any of items 8-16, wherein said monitoring reception of a PEI is carried out to determine reception of a go to sleep signal, GTS, indicating that the UE shall not monitor the PO.

Item 18. The method of item 17, comprising:
determining, based on PEI reception, whether the received PEI is a WUS or GTS.

Item 19. The method of item 18, wherein said monitoring reception of a PEI comprises:
monitoring said PEI occasions in succession; and
going to sleep, responsive to receiving a GTS in one of said PEI occasions, without monitoring any subsequent PEI in the indicator window.

Item 20. The method of items 8 and 18, wherein said monitoring reception of a PEI comprises:
monitoring said PEI occasions in succession; and
proceeding, responsive to receiving a WUS in one of said PEI occasions, to strictly monitor subsequent PEI occasions in the indicator window for a GTS.

Item 21. The method of items 8 and 18, wherein said monitoring reception of a PEI comprises:
monitoring said PEI occasions in succession; and
proceeding, responsive to receiving a GTS in one of said PEI occasions, to strictly monitor subsequent PEI occasions in the indicator window for a WUS.

Item 22. The method of any of items 18-21, wherein at least one of said PEI occasions is reserved for a GTS.

Item 23. The method of any preceding item, comprising:
receiving (810), from the base station, a PEI functionality indicator, wherein monitoring reception of a PEI is carried out in accordance with the PEI functionality indicator.

Item 24. The method of item 23, wherein said PEI functionality indicator configures the UE to either monitor for a PEI addressed to the UE, or to monitor for a group PEI.

Item 25. The method of item 23, wherein said PEI functionality indicator configures the UE to either interpret a PEI sequence received in said PEI occasions as a wake up signal, WUS, indicating that the UE shall monitor the PO, or as a go to sleep signal, GTS, indicating that the UE shall not monitor the PO.

Item 26. The method of any preceding item, wherein the PEI occasions in said indicator window are allocated to different resources in time and/or frequency domain.

Item 27. The method of item 26, wherein said indicator window is a time window, in which all PEI occasions are scheduled at different time domain resources.

Item 28. The method of any preceding item, wherein obtaining configuration comprises:
receiving said configuration, including resources for said PEI occasions, from said base station.

Item 29. The method of any preceding item, comprising:
monitoring said PEI occasions in succession; and
discontinuing, responsive to detecting reception of a PEI in one of said PEI occasions, monitoring of any subsequent PEI in the indicator window.

Item 30. Method for a base station to configure a user equipment, UE, to monitor a paging occasion, PO, for a paging message transmitted from the base station, the method comprising:
configuring a plurality of paging early indicator, PEI, occasions during an indicator window preceding the PO, for use by the UE to monitor for a PEI transmitted by the base station;
transmitting, based on that the UE is to be scheduled, a PEI in at least one of said PEI occasions, indicating that the UE shall monitor said PO.

Item 31. The method of item 30, comprising:
transmitting a plurality of synchronization signal blocks, SSB, in a burst;
transmitting, to the UE, association information which maps identity associated with said SSBs to resources related to said PEI occasions.

Item 32. The method of item 31, wherein said base station transmits in multiple beams, and wherein each beam is associated with resources related to a subset of said plurality of PEI occasions, which subset comprises a multitude of PEI occasions.

Item 33. The method of any of items 30-32, wherein at least one of said PEI occasions is reserved for a PEI addressed to identified UEs.

Item 34. The method of any items 30-33, wherein the PEI is configured as a wake up signal, WUS, responsive to a paging message being scheduled for the UE in said PO.

Item 35. The method of any of items 30-34, wherein at least one of said PEI occasions is reserved for a group WUS.

Item 36. The method of any of items 30-35, wherein at least one of said PEI occasions is reserved for a confirmation PEI.

Item 37. The method of any of items 30-36, wherein at least one of said PEI occasions is reserved for a confirmation PEI associated with a subgroup of UEs.

Item 38. The method of items 34 and either 36 or 37, wherein a confirmation PEI is transmitted to identify that a WUS was sent in the indicator window, based on a paging message being scheduled for the UE in said PO.

Item 39. The method of items 34 and either 36 or 37, wherein a confirmation PEI is transmitted to identify that a WUS was not sent in the indicator window.

Item 40. The method of any of items 30-39, wherein the PEI is addressed either specifically to the UE, or to a subgroup of UEs, or not addressed.

Item 41. The method of any of items 30-40, comprising:
transmitting, based on that the UE is not to be scheduled, a go to sleep signal, GTS, in at least one of said PEI occasions, indicating that the UE shall go to sleep without monitoring said PO.

Item 42. The method of item 41, wherein at least one of said PEI occasions is reserved for a go to sleep signal, GTS.

Item 43. The method of any of items 30-42, wherein the PEI is addressed either specifically to the UE, or to a subgroup of UEs, or not addressed.

Item 44. The method of any of items 30-43, comprising:
transmitting a PEI functionality indicator, configuring the UE for monitoring reception of a PEI.

Item 45. The method of item 44, wherein said PEI functionality indicator configures the UE to either monitor for a PEI addressed to the UE, or to monitor for a group PEI.

Item 46. The method of item 44, wherein said PEI functionality indicator configures the UE to either interpret a PEI sequence received in said PEI occasions as a wake up signal, WUS, indicating that the UE shall monitor the PO, or as a go to sleep signal, GTS, indicating that the UE shall not monitor the PO.

Item 47. The method of any of items 30-46, wherein the PEI occasions in said indicator window are allocated to different resources in time and/or frequency domain.

Item 48. The method of any of items 30-46, wherein said indicator window is a time window, in which all PEI occasions are scheduled at different time domain resources.

Item 49. The method of any of items 30-48, comprising:
transmitting said configuration, including resources for said PEI occasions, to said UE.

Item 50. The method of any of items 30-49, comprising:
determining a PEI occasion among the plurality of PEI occasions, which is not scheduled to any other UE not being configured to detect PEI, wherein the PEI is transmitted in the determined PEI occasion.

1. A method for a user equipment (UE), to monitor a paging occasion (PO), for obtaining a paging message from a base station, the method comprising:
obtaining configuration of a plurality of paging early indicator (PEI), occasions allocated in an indicator window preceding the PO;
monitoring reception of a PEI in the indicator window; and monitoring the PO, responsive to receiving, in at least one of the PEI occasions, a PEI indicating that the UE shall monitor said PO, or
otherwise entering a sleep state without monitoring the PO.

2. The method of claim 1, wherein said base station transmits a plurality of synchronization signal blocks (SSBs), sin a burst, the method further comprising: obtaining association information which maps identity associated with said SSBs to resources related to said PEI occasions.

3. The method of claim 2, comprising:
synchronizing with at least one SSB to determine the associated identity of said at least one SSB;
wherein said monitoring reception of a PEI is carried out on the resources related to one or more PEI occasions associated with the determined associated identity.

4. The method of claim 2, comprising:
receiving a PEI in at least one of said PEI occasions;
determining the identity of at least one of said SSBs, based on the received PEI; synchronizing with an SSB associated with the determined identity.

5. The method of claim 2, wherein said base station transmits in multiple beams, and wherein each beam is associated with resources related to a subset of said plurality of PEI occasions, which subset comprises a multitude of PEI occasions.

6. The method of claim 1, wherein at least one of said PEI occasions is reserved for a PEI addressed to identified UEs.

7. The method of claim 6, wherein monitoring the PO is conditionally carried out responsive to the received PEI being addressed specifically to the UE or to a subgroup comprising the UE.

8. The method of claim 1, wherein said monitoring reception of a PEI is carried out to determine reception of a wake up signal (WUS), indicating that a paging message may be scheduled for the UE in said PO.

9. The method of claim 8, wherein at least one of said PEI occasions is reserved for a group WUS.

10. The method of claim 8, wherein said monitoring reception of a PEI comprises:
monitoring said PEI occasions in succession; and
proceeding to monitor the PO, responsive to receiving a WUS in one of said PEI occasions, without monitoring any subsequent PEI occasion in the indicator window.

11. The method of claim 10, wherein said monitoring reception of a PEI comprises: skipping monitoring of at least one PEI occasion based on knowledge in the UE of such at least one PEI occasion being co-located with another configured signal or channel.

12. The method of claim 8, wherein monitoring the PO is carried out responsive to detecting a WUS in one of said PEI occasions, and detecting a confirmation PEI in another of said PEI occasions.

13. The method of claim 12, wherein at least one of said PEI occasions is reserved for said confirmation PEI.

14. The method of claim 12, wherein the confirmation PEI identifies that a WUS was sent in one or more of the PEI occasions of the indicator window.

15. The method of claim 12, wherein said confirmation PEI identifies that said WUS was addressed to a subgroup comprising the UE.

16. The method of claim 12, wherein a confirmation PEI identifies that a WUS was not sent in any of the PEI occasions of the indicator window.

17. The method of claim 8, said monitoring reception of a PEI is carried out to determine reception of a go to sleep signal (GTS), indicating that the UE shall not monitor the PO.

18. The method of claim 17, comprising: determining, based on PEI reception, whether the received PEI is a WUS or GTS.

19. The method of claim 18, wherein said monitoring reception of a PEI comprises: monitoring said PEI occasions in succession; and going to sleep, responsive to receiving a GTS in one of said PEI occasions, without monitoring any subsequent PEI in the indicator window.

20-29. (canceled)

30. A method for a base station to configure a user equipment (UE), to monitor a paging occasion (PO), for a paging message transmitted from the base station, the method comprising:
configuring a plurality of paging early indicator (PEI), occasions during an indicator window preceding the PO, for use by the UE to monitor for a PEI transmitted by the base station;
transmitting, based on that the UE is to be scheduled, a PEI in at least one of said PEI occasions, indicating that the UE shall monitor said PO.

31-50. (canceled)
